(19) United States
(12) Patent Application Publication
(10) Pub. No.: US 2008/0253930 A1
(43) Pub. Date: Oct. 16, 2008

(54) CODED TUBES AND CONNECTORS FOR MICROFLUIDIC DEVICES

(76) Inventors: Emil P. Kartalov, Pasadena, CA (US); Carl L. Hansen, Vancouver (CA); Stephen R. Quake, Stanford, CA (US)

Correspondence Address: Steinfl & Bruno, 301 N Lake Ave Ste 810, Pasadena, CA, 91101, US

(21) Appl. No.: 12/098,349

(22) Filed: Apr. 4, 2008

Related U.S. Application Data
(60) Provisional application No. 60/922,860, filed on Apr. 11, 2007.

(51) Int. Cl. B01J 19/00; B01L 3/14; B01L 11/00

(52) U.S. Cl. 422/68.1; 422/102; 422/103

(57) ABSTRACT

Tubes and connectors for microfluidic devices are described. The tubes are provided with a coding on their external surface for example, to allow easier identification. The connector comprises a plurality of through holes going through the connector. Each through hole can accommodate a pin for connection of microfluidic device ports on one side of the pin and connection of a reagent or sample liquid tube on the other side of the pin.

### CROSS REFERENCE TO RELATED APPLICATIONS

This application claims priority to U.S. Provisional Application 60/922,860 filed on Apr. 11, 2007, the contents of which are incorporated herein by reference in their entirety.

### STATEMENT OF GOVERNMENT GRANT

The U.S. Government has certain rights in this invention pursuant to Grant No. DAAD19-001-0392 awarded by DAIUA and Grant No. HG-01642 and 5T32-GM07616 awarded by the National Institutes of Health.

### FIELD

The present disclosure relates to the field of fluidics and in particular to coded tubes and connectors for microfluidic devices.

### BACKGROUND

Microfluidic devices and systems are commonly used in the art for processing and/or analyzing very small samples of fluids, such as samples in the 10 ml to about 5 ml size range. In such microfluidic devices and systems, the integration of many elements in a single microfluidic device has enabled powerful and flexible analysis systems with applications ranging from cell sorting to protein synthesis. Some microfluidic operations that are functional to the performance of such applications include mixing, metering, pumping, reacting, sensing, heating and cooling of fluids in the microfluidic device.

In the perspective view of FIG. 1, a microfluidic chip or device (10) is illustrated. As better shown in the simplified schematical view of FIG. 2, the device comprises a matrix (20) including a plurality of flow channels (30) defined in the matrix and suitable to introduce a sample and/or reagents in the chip and to control air flow and pressure within the chip. The device can also comprise a corresponding plurality of selectively controllable, and possibly valved, microchambers. As further shown in FIG. 1, the device (10) can also comprise a plurality of ports (15). Ports (15) are configured to provide contact between the microfluidic channels of FIG. 2 and the external environment through tube lines. Microfluidic devices like the one described in FIGS. 1 and 2 or similar to that can be found, for example, in the following U.S. published patent applications: US 2006/0019263, US 2007/0048192, or US 2008/0013092, all of which are incorporated herein by reference in their entirety.

In view of the above and other applications, it is clear that microfluidics is Ma novel tool that is establishing itself as the next technological step in a wide range of medical and biological applications, e.g. protein crystallization, de novo DNA sequencing, forensics, and diagnostics.

Regardless of the particular application, the same problems of interfacing with the outside macro world inevitably appear. A few array applications lend themselves to high parallelism in control and flow structures, which allows pressure actuation and reagent flow to be done by very simple, highly parallel means with only a few contacts to the outside world. However, this is a fortuitous exception. In general, dozens of tube lines are plugged in one at a time, and the fully assembled system is a jungle of colorless microline cables that take even more time to debug or reconnect as necessary.

### SUMMARY

According to a first aspect, a microfluidic system is provided, comprising: a microfluidic device comprising a plurality of microfluidic channels, and an arrangement of tubes configured to be connected to the microfluidic device, wherein at least some of the tubes are provided with a coding, thus allowing tubes with a particular coding to be identified.

According to a second aspect, an arrangement comprising a plurality of tubes attached together and configured to be connected with a microfluidic device comprising microfluidic channels is provided, wherein the tubes are coded to allow their identification.

According to a third aspect, a connector for connecting tubes to a microfluidic device is provided, the connector comprising: a first surface configured to be put in contact with the tubes; a second surface configured to be put in contact with the microfluidic device; a plurality of through holes going through the connector from the first surface to the second surface, the through holes configured to establish fluidic communication between the tubes and the microfluidic device.

Further embodiments are provided through the specification, drawings and claims of the present disclosure.

### BRIEF DESCRIPTION OF THE DRAWINGS

FIG. 1 shows an already discussed schematic perspective view of a known microfluidic chip or device.

FIG. 2 shows an already discussed schematic top view of the circuital arrangement inside the chip or device of FIG. 1.

FIG. 3 shows two bar-coded tubes in accordance with the present disclosure.

FIG. 4 shows two color-coded tubes in accordance with the present disclosure.

FIG. 5 shows a cross sectional view of a connector in accordance with the present disclosure.

FIG. 6 shows a top view of the connector of FIG. 5.

FIGS. 7A-7C show three different embodiments of the connector according to the present disclosure.

FIG. 8 shows a perspective view of a manifold with reservoirs containing reagents to be fed via tubing to the microfluidic chip.

### DETAILED DESCRIPTION

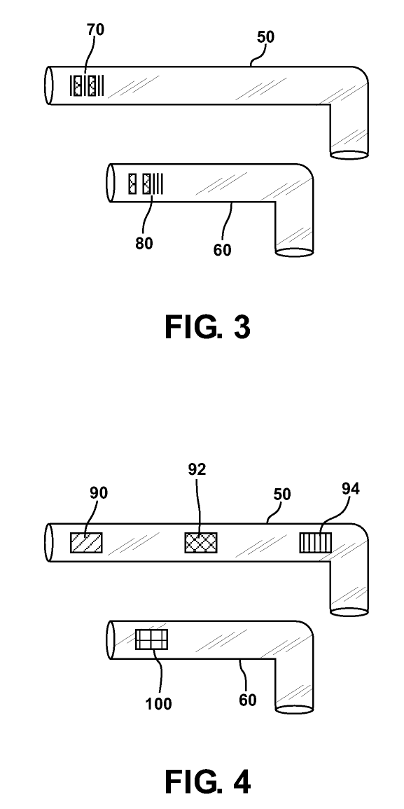

According to a first embodiment of the present disclosure, tube lines for use with a microfluidic device are coded. For example, FIG. 3 schematically shows two tubes (50), (60) each of which is provided with a respective bar code (70), (80). A further type of code to be used could be a color-based coding like the one shown in FIG. 4, where element (90) indicates a first color, and element (100) indicates a second color. Color coding does not need to be restricted to a single color per tubing line, but for example may be arranged in sequential bands of different colors on the same tubing, to increase the coding bandwidth, as shown by elements (92) and (94) in FIG. 4.

Tube coding will easily allow one tube to be distinguished from another and will also allow the tubes to be bunched, arranged or attached in flat parallel or circular arrays, just like cables and ribbons in electronics. Other types of coding suitable with the present disclosure can include numerical coding, patterned coding, cross-sectional coding and so on. Also, the code might not even be visible to the eye, e.g., magnetic nanoparticles and quantum dots at low volumetric concentration in the bulk, or even just dielectric permittivity coefficient variations designed to have the same function. Similarly, the colors can be arranged geometrically in a number of different ways, e.g. as rings in fashion analogous to electrical resistor coding.

Beyond mere visual identification, the coding according to the present disclosure can make identification and connection amenable to automation. For example, color coding would allow visual and optical identification, bar coding would allow laser scanner identification, quantum dot coding would allow fluorescence optical identification, magnetic coding would allow magnetic readout identification, and electrical resistance (e.g., electrical resistance of a section of the tube) and/or capacitance coding (e.g., capacitance of a length of plastic tubing) would allow electrical identification.

The person skilled in the art will understand that the above mentioned codings constitute specific examples that by no means exhaust the coding possibilities. By way of additional and non limiting examples, volume-embedded magnetically or optically or electrically detected nanoparticles of particular density, configuration or spectral characteristics can be considered. Additionally, any attachment to the wire or addition thereof that could serve a similar purpose can also be considered.

With further reference to the embodiment shown in FIGS. 3 and 4, it should be noted that the coding can be arranged in a number of functionally identical ways, such as going all the way around the surface of the tubing, being embedded inside the bulk of the tubing material, and so on.

According to a further embodiment, as also shown in FIGS. 3 and 4, each tube is kept transparent (or at least partially transparent, e.g., translucent to allow tracking of the advance of the reagents, while coding can be confined to a small region (70), (80), (90), (92), (94), (100). The person skilled in the art, faced with this solution, will understand that color coding can be obtained, for example, by simply putting a dye in the tube polymer. As already mentioned above, color coding can be provided on the entire tube (e.g., in cases where a single color is used per tube) or on a specific portion of the tube. Tubes extruded from a polymer can, for example, be individually doped at specific locations while the material is still hot and gooey.

According to another embodiment of the present disclosure, a fluidic connector is provided, to allow quick and correct establishment of a large number of connections to a microfluidic device.

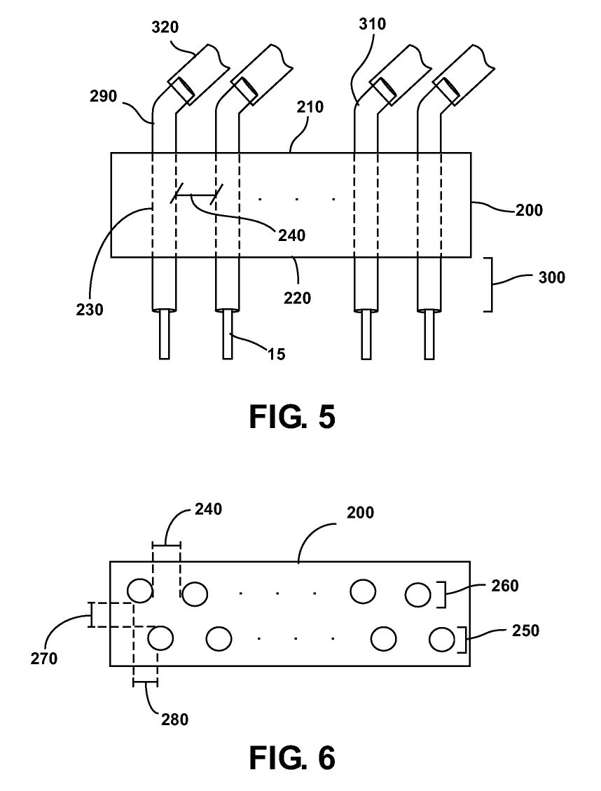

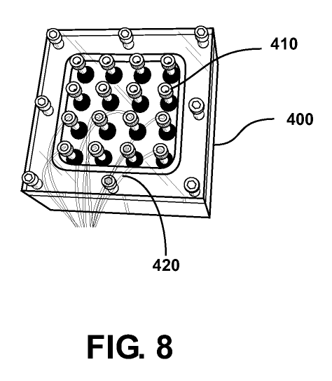

FIG. 5 shows a cross sectional view of a connector (200) having a top surface (210) and a bottom surface (220). Connector (200) can be made of aluminum. The bottom surface (220) is intended toe be put in contact with the microfluidic device, while the top surface is intended to put on the side of a manifold (shown in FIG. 8 below) containing the reagents to be fed to the microfluidic device.

The connector (200) comprises a plurality of through holes (230) separated by a distance or pitch (240). As also shown in FIG. 6, which depicts a top view of the connector (200), two rows of through holes (250), (260) can be provided. Each row can comprise, for example, 16 holes bored at a 0.1 inches pitch. The value of the pitch can be based on the size of the tubes to be connected with the through holes, the architecture of the microfluidic chip, and the size of the microfluidic channels. The value of the pitch is usually a balance between device density and robustness considerations in fabrication.

Through holes of the first row (250) are separated from through holes of the second row (260) by a distance (270), e.g., 0.1 inches. Moreover, longitudinal positioning of the first row (250) is offset with respect to longitudinal positioning of the second row (260) by an offset distance (280), e.g., 0.05 inches. As pointed out above with reference to the pitch value, factors such as separation between the holes and the rows, number of rows and offset can be varied to optimize the geometry of the connector among function, robustness and economy of space.

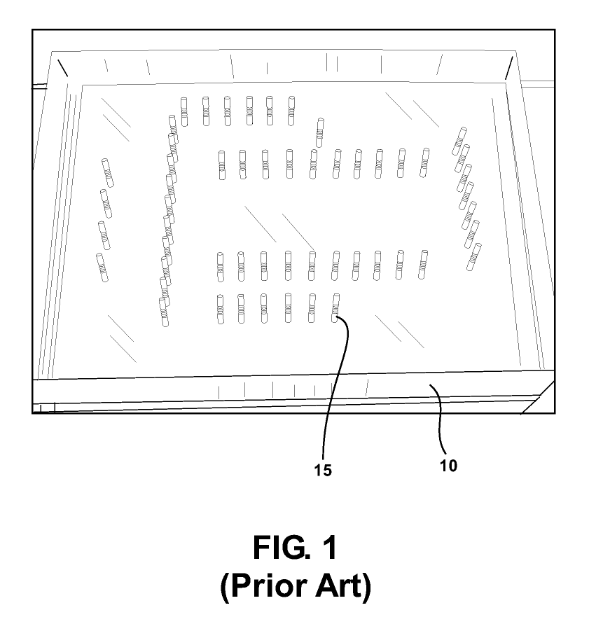

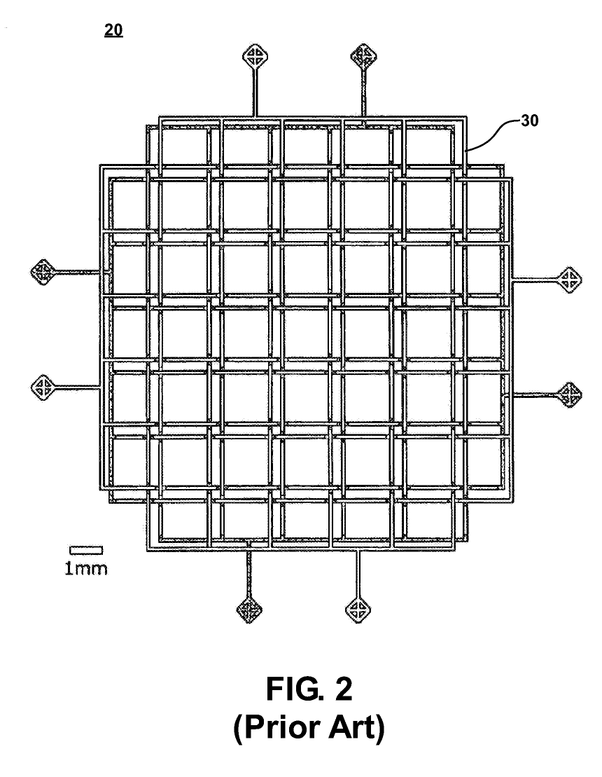

Turning to FIG. 5, pins (290) are accommodated by each through hole (230). In particular each pin (290) extends a certain distance (300), e.g. 0.25 inches, from the bottom surface (220) of the connector (200). The extension (300) of the pin allows insertion and snug fit with the opening on the respective port on the chip, see ports (15) shown in FIG. 1. On the other hand, on the top surface side (210), the top surface of each pin (290) can be bent 110) at an angle, e.g. a 90 degree angle, and interfaces with tubing (320) adapted to be connected to a reagent manifold (shown in FIG. 8 below), e.g., microbore Tygon® tubing. The bending is done to ensure that the physical weight of the tubing entering the connector does not mechanically deform the chip. Also, it is neater to work with, also because it keeps the surface of the chip open to allow for unrestricted imaging. On the bottom surface side, the bottom surface of each pin (290) is adapted to be connected to the ports (15) of the microfluidic device (10), as also shown in FIG. 1. The pins (290) can be stainless steel pins such as 1-inch tong, 20-gauge stainless steel pins. Alternatively, polymer pins and/or glass pins can be provided.

The connector thus described can be easily inserted and removed from the microfluidic device to make quick connections. Generally speaking, connection occurs by way of alignment and push steps, while disconnection occurs by way of a pull out step. For repeated use, care should be taken that pulling the connector out of the microfluidic chip does not: delaminate the binding between chip and substrate, which can be significantly weaker than the friction between connector pins and port openings. In the latter case, the chip is usually held down or secured by some sort of mechanical clamp, to prevent delamination during: disconnection. By standardizing reagent input/output and control input patterns, a variety of devices may easily be interfaced to external fluidic hardware. This also allows for cross-compatibility between a variety of devices and further facilitates exchange of devices from fluidic set-ups.

The connector discussed above can connect from the top or the bottom of the microfluidic device. Exemplary fabrication processes of the connector include, but are not limited to, micromachining, injection molding, laser ablation and so on.

The person skilled in the art will understand that exact dimensions as well as hole stacking configuration inside the connector may be different in different embodiments, as well as the number of holes and hole rows and columns. In addition, a connector can comprise holes of different size and profile. Furthermore, according to additional embodiments of the present disclosure, the connector may connect to input/output ports at different angles and/or different heights of entry and to different layers of the microfluidic chip. In other words, the height of the ports (15) of FIG. 1 can vary among different ports, and the length of the bottom portions (300) shown in FIG. 5 can vary correspondingly.

According to another embodiment of the present disclosure, connectors can be designed such that they compress the total area of the connection between the tubing and the microfluidic chip. For example, an input any of 20×20 tubes each having a 1 mm diameter and a 2 mm center-to-center distance from the other tubes has a 4 cm×4 cm total area. Within a connector according to such embodiment, the diameter could shrink down to a 100 micron diameter and a 200 micron center-to-center distance, thus reducing the contact area to 4 mm×4 mm. By way of example, the tubes usually have a much larger diameter than the pins (290) of the connector (200). Twenty individual tubes arranged at 2 mm center-to-center in parallel will take a distance of 2 mm×20=40 mm=4 cm. Even if a ribbon-like arrangement is used, the tubes cannot be arranged closer than their diameters, and thus the width used would be 1 mm×20=20 mm=2 cm. By comparison, the connector can have in accordance with such embodiment, pins that are as small as a standard microchannel width (e.g., 100 micron) arranged at a standard minimal spacing of 100 microns border-to-border (which means 200 microns center-to-center). Then 20 pins would take 20×200 microns=4 mm, instead of 2 cm above. Thus, the overall estate used within the chip itself would be much smaller. Such embodiment is advantageous for chip manufacturing since there is no space waste on a wafer, thus allowing more chips per process run to be obtained.

According to a further embodiment of the disclosure, the tubing itself does not need to go through the connector and the connector material itself can serve as tubing.

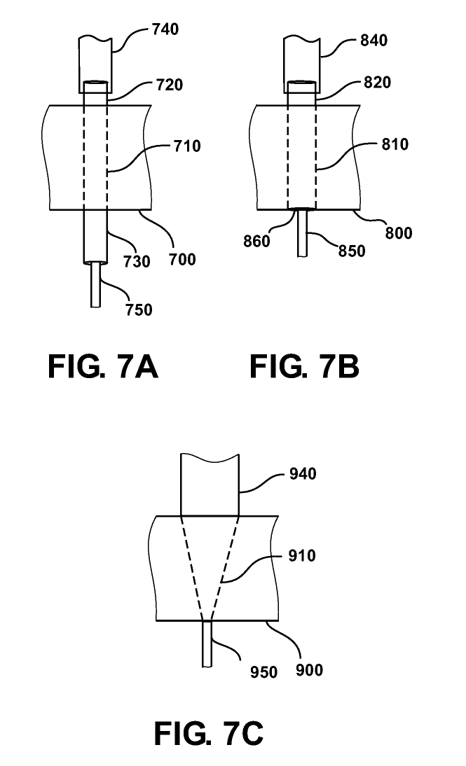

In other words, the tubing can connect to a set of pins just protruding from the connector itself and leading into the respective through holes or chutes, which themselves lead to the micropins or ports (15) that enter the chip, all in parallel, substantially as shown in FIG. 5. Alternatively, the through holes can be used as channels or tubing themselves without need of pins (See also FIGS. 7B and 7C below). A further alternative could be that of having the connector serve as a funneling chip itself with through holes having a variable section along the height of the connector, so that the connector would serve as a funneling chip itself, connecting the tubing of the macroworld to the microworld of the microchannels, as also shown in FIG. 7C below. Therefore, according to some embodiments of the present disclosure, the hollow pins do not need to be present in all cases In such “pinless” embodiments, alignment mechanical contact and surface tension of the liquid will allow the connection to be neat and air-tight.

The various embodiments discussed in the above paragraph are shown in FIGS. 7A-7C where, for clarity reasons, the dimensions have not been drawn to scale. FIG. 7A shows an embodiment substantially similar to the one shown in FIG. 5, where a connector (700), through hole (710), upper pin portion (720), lower pin portion (730), tube (740) and microfluidic chip port (750) are shown. In this embodiment, the ports (750) are a little bit smaller than the pins (730), so that when the pins (730) are inserted, the ports (750) are slightly stretched and thus hold the pins (730) snugly in place. FIG. 7B shows a first pinless embodiment, where a connector (800), through hole (810), upper pin (820), tube (840) and microfluidic chip port (850) are shown, where there is no pin between the through hole (810) and the microfluidic chip port (850). In this embodiment, the bottom openings of the connector (800) are aligned precisely over the ports (850) and the connector (800) is pressed tightly against the surface of the chip. Under these conditions, each fluid will move under pressure through the connector and into the respective port (850) in the chip. For any unwanted spillage to occur, the applied static pressure must exceed the stress within the chip produced by the pressing of the connector onto it, as well as exceed the fluidic resistance due to surface tension at the point (860) between the opening in the connector (800) and the top in the respective port (850). When hydrophobic material is used, the fluid (mostly water) would produce a meniscus that will apply counterpressure that increases with decreasing of the distance between the chip and connector surfaces, FIG. 7C shows a second pinless embodiment, where a connector (900), a funnel-shaped through hole (910), tube (940) and microfluidic chip port (950) are shown.

By way of example and not of limitation, the standard used for pins can be a 23-gauge hollow pin (outer diameter, about 620 microns) to connect to a microfluidic chip port punched with a 20 to 23 gauge circular cutter. More generally, a port diameter is in the 80 microns to several thousand microns range. Tygon® tubing can be used with an internal diameter slightly smaller than the outer diameter of the hollow pin. Thus, in the case of 23-gauge hollow pins, Tygon® tubing having an inner diameter of 0.020 inches (about 500 microns) can be used.

Embodiments of the present disclosure can be provided where the configurations shown in FIGS. 3 and 4 are combined with the configurations shown in FIGS. 5, 6 and 7A-7C thus effectively combining the advantages of both solutions.

As already discussed above, the tubing (320) to be interfaced with the microfluidic chip (10) through the connector (200) contains reagents usually coming from reservoirs or wells contained in a manifold. FIG. 8 shows a manifold (400) containing reservoirs or wells (410), each reservoir connected to a respective tube (420). The various tubes (420) are attached or arranged together and interfaced with the connector (200) shown in FIGS. 5, 6 and 7A-7C. Connections of the various tubes (420) can facilitate their insertion in the connector (200). In particular, if the connection is such to allow a particular distance between the tubes (420) to be obtained, the tubes (420) can be inserted in the connector (200) by way of a one-touch (single step) operation, with a considerable time saving, especially for cases where chips need to be connected and reconnected quickly and reliably to reagents from macro reservoirs.

The manifold (400) of FIG. 8 is usually kept at higher pressure than the ambient one. Therefore, the liquid move into the tubing from the wells (41Q). According to a: further embodiment of the disclosure, a connector can be provided where the through holes perform the function of the tubes and the wells are built right into the connector (e.g., machined into the top surface of the connector). In such embodiment the connector would also perform the function of a fluidic reservoir. With reference, for example, to the embodiment shown in FIG. 6, the openings can be seen as wells that can be filled with reagents. These wells are then funneled down to a smaller diameter, as shown in FIG. 7C, to match the size and/or spacing of the microfluidic chip ports. Both pin-ful and pin-less methods of connection to the chip can be used in conjunction with these wells, which can have different or varying shapes and sizes and be arranged in different ways.

Accordingly, what has been shown are coded tubes and connectors for microfluidic devices. While these tubes and connectors have been described by means of specific embodiments and applications thereof, it is understood that numerous modifications and variations could be made thereto by those skilled in the art without departing from the spirit and scope of the disclosure. It is therefore to be understood that within the scope of the claims, the disclosure may be practiced otherwise than as specifically described herein.

What is claimed is:

1. A microfluidic system comprising:
a microfluidic device comprising a plurality of microfluidic channels, and
an arrangement of tubes configured to be connected to the microfluidic device, wherein at least some of the tubes are provided with a coding, thus allowing tubes with a particular coding to be identified.

2. The microfluidic system of claim 1, wherein the coding is selected from the group consisting of at least one of: a bar code, color coding, optical coding, magnetic coding, quantum dot coding, capacitive coding, and electrically resistive coding.

3. The microfluidic system of claim 2, wherein the tubes are made of a polymer, and wherein the color coding is provided by a dye in the polymer.

4. The microfluidic system of claim 1, wherein the tubes provided with the coding are at least partially transparent.

5. The microfluidic system of claim 4, wherein the coding is provided on a limited portion of each tube.

6. The microfluidic system of claim 1, wherein the tubes are arranged together.

7. An arrangement comprising a plurality of tubes attached together and configured to be connected with a microfluidic device comprising microfluidic channels, wherein the tubes are coded to allow their identification.

8. A connector for connecting tubes to a microfluidic device, the connector comprising:
a first surface configured to be put in contact with the tubes;
a second surface configured to be put in contact with the microfluidic device;
a plurality of through holes going through the connector from the first surface to the second surface, the through holes configured to establish fluidic communication between the tubes and the microfluidic device.

9. The connector of claim 8, further comprising a plurality of pins, each pin accommodated in a corresponding through hole.

10. The connector of claim 9, wherein each pin extends a first distance below the first surface and a second distance above the second surface.

11. The connector of claim 10, wherein the first or second distance for one pin is configurable to be different from the first or second distance for another pin.

12. The connector of claim 8, wherein the plurality of through holes comprises one or more rows of through holes.

13. The connector of claim 12, wherein the one or more rows of through holes are two rows of through holes.

14. The connector of claim 13, wherein the two rows of through holes are offset with respect to each other.

15. The connector of claim 9, wherein each pin is bent at an angle along said second distance.

16. The connector of claim 15, wherein the angle is a 90 degree angle.

17. The connector of claim 8, wherein the tubes are provided with a coding.

18. The connector of claim 17, wherein the coding is selected from the group consisting of at least one of: a bar code, color coding, optical coding, magnetic coding, quantum dot coding, capacitive coding, and electrically resistive coding.

19. The connector of claim 18 wherein the tubes are made of a polymer, and wherein the color coding is provided by a dye in the polymer.

20. The connector of claim 17, wherein the tubes provided with the coding are at least partially transparent.

21. The connector of claim 20, wherein the coding is provided on a limited portion of each tube.

22. The connector of claim 8, wherein the through holes are funnel-shaped.

23. The connector of claim 8, further comprising a plurality of pins extending above the first surface and below the second surface, but not extending along the through holes.

24. The connector of claim 8, further comprising wells connected with each through hole, each well to be filled with reagents.

25. The connector of claim 24, wherein the through holes have a funnel shape.

26. The connector of claim 24, further comprising a plurality of pins located along the second surface.
